(19) United States
(12) Patent Application Publication
(10) Pub. No.: US 2007/0045961 A1
(43) Pub. Date: Mar. 1, 2007

(54) Method and system providing for navigation of a multi-resource user interface

(76) Inventor: Robert P. Morris, Raleigh, NC (US)

Correspondence Address: SCENERA RESEARCH, LLC, 111 Corning Road, Suite 220, Cary, NC, 27518, US

(21) Appl. No.: 11/217,517

(22) Filed: Aug. 31, 2005

(51) Int. Cl. G06F 19/00; A63F 9/24; A63F 1/00

(52) U.S. Cl. 273/292; 463/11; 463/16; 463/42

(57) ABSTRACT

A method and system is provided for navigating a multi-resource user interface on a display of an electronic device. Method and systems aspects include displaying a deck of cards representing device resources in a presentation space occupying only a portion of a display screen, wherein a top card overlaps other cards in the deck such that no user interface controls of the other cards are visible and only the top card is selectable by a user; and in response to the user activating an input control to navigate the cards in the deck, moving the top card to another position in the deck and revealing a next card in the deck.

### FIELD OF THE INVENTION

The present invention relates to graphical user interfaces, and more particularly to navigation of a multi-resource user interface.

### BACKGROUND OF THE INVENTION

Mobile computing devices such as mobile telephones, personal digital assistants (PDAs) and laptops are designed to perform not only many of the functions of desktop computers, but also special functions that are exclusive to the mobile environment. As the number of functions and features of mobile devices grows, the user interface (UI) design of mobile devices must be changed in order to maintain the ease of use of the devices. However, the user interfaces of mobile devices face intrinsic limitations due to physical constraints such a small screen size, lack of a keyboard or mouse, and limited memory and storage space. A user interface on a mobile device having such physical constraints needs to present its functions and features in a fast and concise manner.

Traditional graphical user interfaces employed on personal computers (PCs) generally cannot be utilized directly on a mobile device without significant alteration due to these limitations. For example, files and applications are typically organized on and displayed in a hierarchical manner. On PCs and other electronic devices, having relatively large displays, browser applications, such as MICROSOFT™ WINDOWS™ EXPLORER™, can be used to efficiently view and navigate a hierarchical arrangement of folders and subfolders and/or a hierarchical arrangement of menus and submenus for the various application functions. These browser applications typically support non-linear navigation of hierarchical file structures, making it possible for users to jump between certain nodes and levels in the hierarchy without having to traverse through each node in the file structure between source and destination nodes. Similarly, complex application menu systems can be presented on larger displays in a tiled manner to aid users in navigating to the various menu functions. Hierarchical data structures are typically presented on PC displays and portable electronic devices in tree, menu, or folder views. However, tree and menu views can require a relatively large amount of display area to navigate to leaf nodes (for example, applications or files) in the tree structure, and are navigated more easily with use of a mouse.

Another solution is the use of a graphical user interface that uses tabs. A tab in graphical user interfaces is a typically rectangular small box, usually containing a text label or graphical icon, that is most often located directly on top of a view pane. View pane tabs resemble traditional card tabs inserted in paper files, or card indexes. When activated (e.g., by a mouse click), the view pane displays objects in the view pane associated with the tab. Although a single tab may not be that useful, a tab group comprising several view panes and their tabs allows the user to switch quickly between different view panes. The active (or foreground) tab is typically highlighted to make it stand out from the rest of the tab group, though sometimes, only color or size changes to indicate the currently selected tab. Since the tabs share the same part of the window, it is not necessary to use scrollbars in order to fit more inputs and outputs on the screen than otherwise possible. Although tabs in modern GUIs may make option-laden dialog boxes and web pages easier to navigate, the use of tabs require too much screen area to be useful on mobile computing devices.

### BRIEF SUMMARY OF THE INVENTION

The present invention provides a method and system for navigating a multi-resource user interface on a display of an electronic device. Method and systems aspects include displaying a deck of cards representing device resources in a presentation space occupying only a portion of a display screen, wherein a top card overlaps other cards in the deck such that no user interface controls of the other cards are visible and only the top card is selectable by a user; and in response to the user activating an input control to navigate the cards in the deck, moving the top card to another position in the deck and revealing a next card in the deck.

According to the method and system disclosed herein, the present invention provides an intuitive navigation method for users, which is based on a metaphor of a deck of cards, and conserves limited screen space of the electronic device.

### BRIEF DESCRIPTION OF SEVERAL VIEWS OF THE DRAWINGS

FIG. 1 is a flow diagram illustrating a process for allowing a user to navigate a multi-resource user interface on a display of an electronic device according to an exemplary embodiment.

FIG. 2 is a block diagram illustrating a system for providing for the navigation of a multi-resource user interface on a display of an electronic device according to an exemplary embodiment.

FIGS. 3A and 3B are diagrams illustrating an embodiment of the system providing the user with a visual indication of where he or she is in a deck or sub-deck by providing nesting and location information.

FIG. 4 is a flow diagram Illustrating the process performed by the graphics subsystem using input from the input subsystem for navigating a multi-resource user interface in further detail.

FIG. 5 is a block diagram illustrating an embodiment of the system in which multi-deck selection is allowed for simultaneous navigation.

FIG. 6 is a flow diagram illustrating the process of displaying content of a related deck as the user navigates a focus deck in accordance with an exemplary embodiment.

FIG. 7 is a diagram illustrating the display of a deck with focus and a deck that has a defined relationship with the focus deck.

FIG. 8 is a block diagram illustrating an exemplary embodiment for displaying an open resource and for performing administrative functions on the open resources, which include the decks.

FIG. 9 is block diagram illustrating additional components of the system for implementing the present invention according to an exemplary embodiment.

### DETAILED DESCRIPTION OF THE INVENTION

The present invention relates to navigation of a multi-resource user interface. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

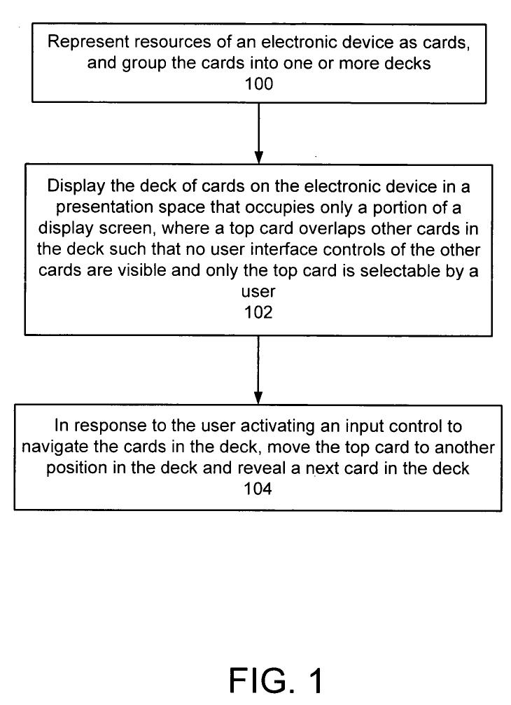

FIG. 1 is a flow diagram illustrating a process for allowing a user to navigate a multi-resource user interface on a display of an electronic device according to an exemplary embodiment. The process begins in block 100 by representing resources of an electronic device as cards, and grouping the cards into one or more decks. As used herein, a resource may refer to any physical or logical part of a computer system or network that can be used by or allotted to the computer system while it is running. Examples of physical resources may include a disk drive, printer, and memory, and examples of logical resources may include software applications, uniform resource locators (URLs), menus, and folders. As described above, many types of computer resources are organized in a hierarchical manner, e.g., a hierarchical arrangement of folders and subfolders, and a hierarchical arrangement of menus and some-menus for applications.

In block 102, the deck of cards is displayed on the electronic device in a presentation space that occupies only a portion of a display screen, where a top card overlaps other cards in the deck such that no user interface controls of the other cards are visible and only the top card is selectable by a user. In block 104, in response to the user activating an input control to navigate the cards in the deck, the top card is moved to another position in the deck and revealing a next card in the deck.

In accordance with the exemplary embodiment, displaying a deck of non-overlapping cards as described above conserves limited screen space on the electronic device, while providing an intuitive navigation method for users, as almost everyone understands the metaphor of a deck of cards.

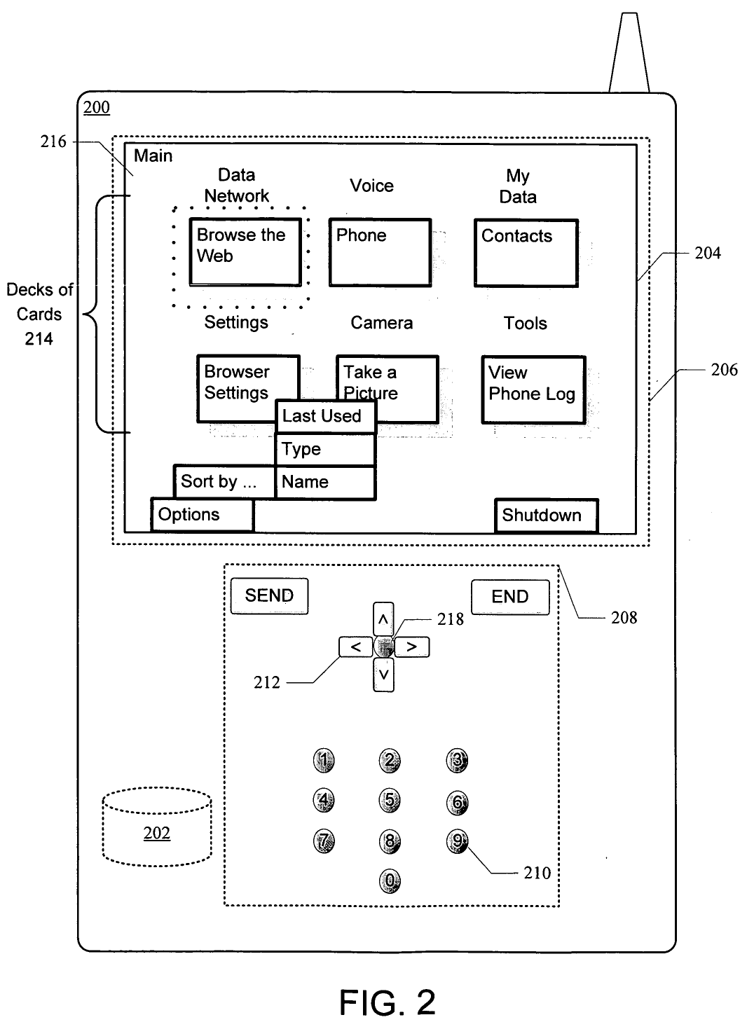

FIG. 2 is a block diagram illustrating a system for providing for the navigation of a multi-resource user interface on a display of an electronic device according to an exemplary embodiment. While a preferred embodiment is described in connection with the mobile electronic device 200 illustrated in FIG. 2, it will be understood that the techniques described here can be carried out using any electronic device having like components and circuitry, including, but not limited to, a PC, a television, a camera, an appliance, and the like.

The system 200 includes a display 204, a graphics subsystem 206 (depicted by a dashed box) coupled to the display 204, and an input subsystem 208 (depicted by a dashed box) coupled to the graphics subsystem 204. The input subsystem 208 is operatively coupled to at least one input control, such as the keypad 210, button 212 or the pointing device 218. In addition, the display 204 can be a touch-screen display capable of receiving input information via the input subsystem 208. Other pointing devices, such as a stylus or a light pen (neither shown) can be operatively coupled to the input subsystem 208 system and/or the display 204. In addition to the above, the system includes a processor (not shown) coupled to the memory 202, display 204, graphics subsystem 206, and input subsystem 208, for executing programmable instructions stored in the memory 202 for controlling the operation of the system 200. Actions performed by the graphics subsystem 206 and/or input subsystem 208 can be carried out, at least in part, using the processor.

The graphics subsystem 206 is configured to display at least one deck of cards 214 on a presentation space of the display 204 that occupies only a portion of a main display screen 216. In a preferred embodiment, multiple decks of cards 214 are displayed in respective portions of the display screen, as shown. The decks 214 and cards are stored in memory 202. In accordance with the preferred embodiment, the decks 214 can be hierarchical to represent hierarchical resources, such as a file system or menu structure, for example, and a deck 214 may include one or more sub-decks. As described above, each of the decks 214 are displayed with only the top card showing, as the top card overlaps the other cards in the deck 214. Cards can be organized into multiple decks 214 by their relationship to one another, such as those that use a common piece of hardware, such as a camera lens, and those that may not be related except that they perform a similar type of function, such as configuration applications. Card and deck organization may be user specified, or the system may alter the card and deck organization based on user activities. For example, cards that are used most often or more recently, may be placed near the top of a deck 214.

The graphics subsystem 206 is configured to allow for deck-level navigation for selection of a card within a deck 214, or window-level navigation for selection of a particular deck 214. The input subsystem 208 is configured to determine when a card within a deck 214 is selected by detecting a particular action from the input control, such as a pair of left and right buttons 212, wherein activation of a first one of the buttons 212 displays the next card in the deck 214, and activation of a second one of the buttons 212 displays a previous card in the deck 214 to allow the user to traverse the deck in a forward and a reverse direction.

The input subsystem 208 is configured to determine window-level navigation for deck selection by detecting another action from the user, either from the same input control used for card navigation used in a different manner (e.g., double pressing the left and right buttons 212), or from a different input control, such as the pointing device 218. The graphics subsystem 206 is configured to highlight the selected deck 214, which has focus (e.g., shown by the dashed lines around the “data network” deck). As used herein, a component is said to have “focus” when the component is in a state of being capable of receiving input from an input device, such as a keyboard or a mouse. Similarly, a component that does not have focus is incapable of receiving input from an input device. It will be understood that in addition to components, any portion of a GUI (for example, windows) can be said to either have or not have focus. Alternatively, the selection can occur in response to detecting the activation of a particular keystroke on a keypad 210, such as the activation of a “<SEND>” keystroke while a cursor 818 is active in the selection component. In addition, the input subsystem 208 is configured to determine, in conjunction with the graphics subsystem 206, whether the selected deck 214 has focus of an input device or not.

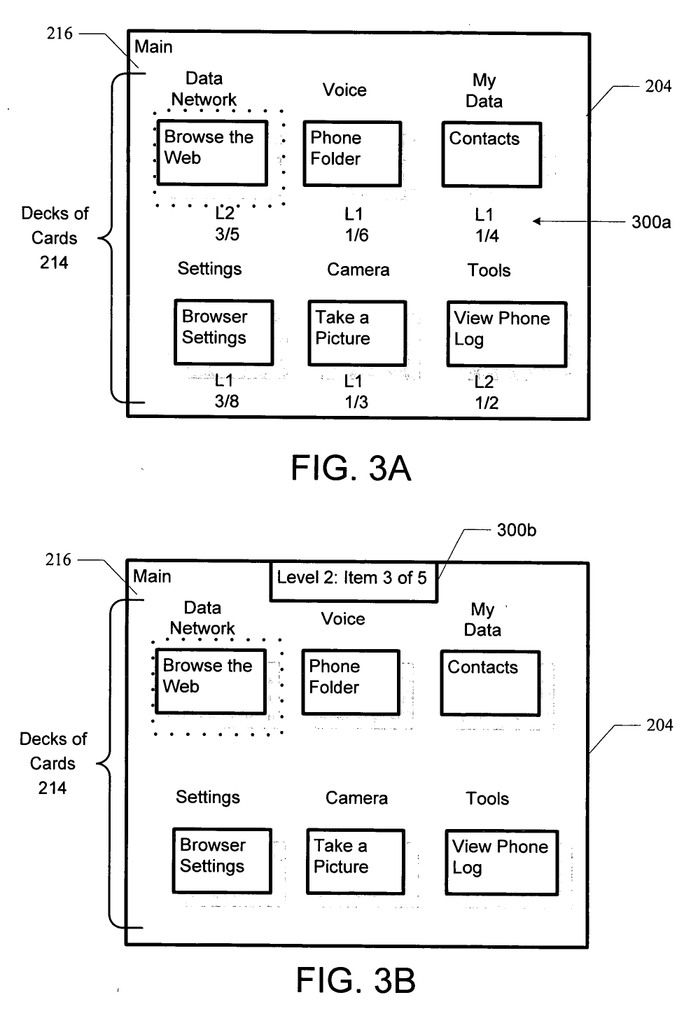

In an exemplary embodiment, at least one of the decks 214 includes a card representing a nested sub-deck of cards. When the card representing the nested sub-deck is selected, the sub-deck is then displayed with a next card in the sub-deck displayed as a top card in the displayed sub-deck. In order to aid user navigation of a deck having a sub-deck, according to an exemplary embodiment, the graphics subsystem 206 may be configured to provide a visual indication to the user of a current location of navigation within the selected deck 214, as shown in FIGS. 3A and 3B.

FIGS. 3A and 3B are diagrams illustrating an embodiment of the system providing the user with a visual indication of where he or she is in a deck or sub-deck by providing nesting and location information. In FIG. 3A, nesting and location information 300a are displayed for each deck. The nesting and location information 300a may include a deck level indication to indicate the location within the deck 214. For example, level 1 (L1) may indicate navigation within the focus deck, level 2 (L2) may indicate navigation within a first sub-deck, level 3 (L3) may indicate navigation within a second sub-deck, and so on. The nesting and location information 300a may also include a card level indication to show the current card location within the deck focus 214. The card level indication may show which card in the deck is on top and how many total cards the current deck or sub-deck includes. In the example shown, “⅗” indicates that the top card is card 3 in a deck of 5 cards. FIG. 3B shows an alternative embodiment, where rather than displaying the nesting and location information 300a for each deck 214, the nesting and location information 300b is displayed in the main display screen, or on a separate window (e.g., “Level 2: Item 3 of 5”) for the deck 214 with focus.

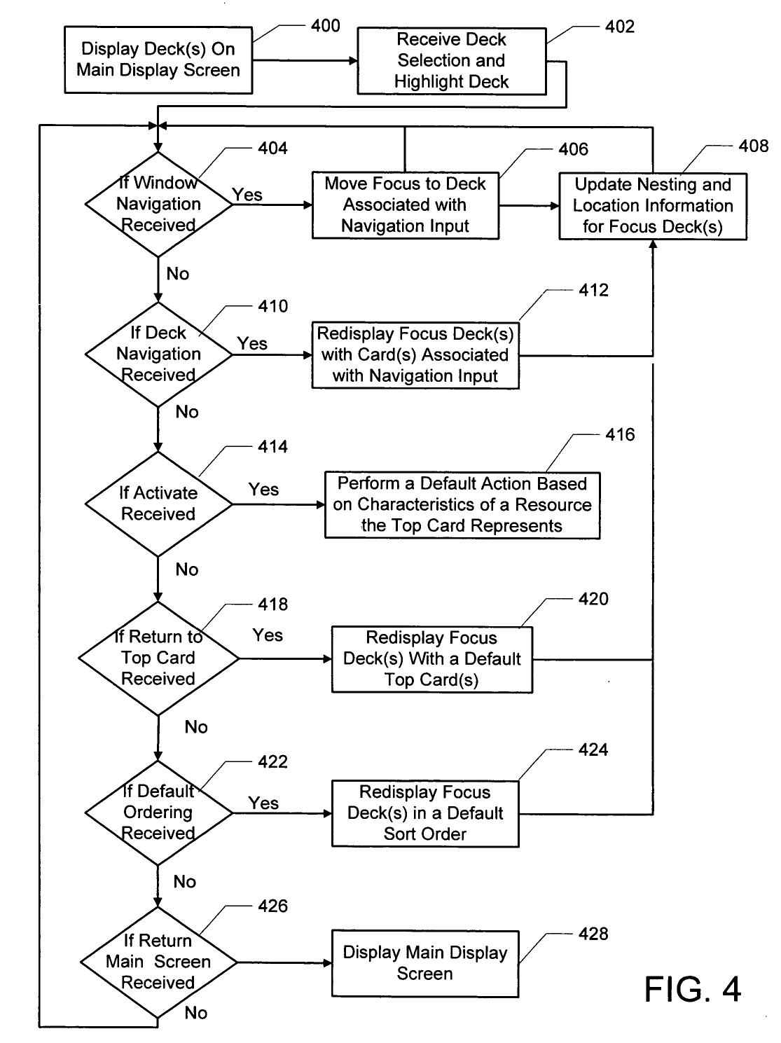

FIG. 4 is a flow diagram illustrating in further detail the process performed by the graphics subsystem 206 using input from the input subsystem 208 for navigating a multi-resource user interface. The process begins in block 400 by displaying the decks 214 on the main display screen 216. In block 402, an indication of a selected deck 214 is received and the selected deck is highlighted. In block 404, if a window-level navigation input is received, then in block 406, focus is moved to the deck 214 associated with the navigation input. In an exemplary embodiment, menus and soft keys may change based on the deck or decks 214 with focus. In block 408, the nesting and location information for the focus deck is updated in block 408.

In block 410, if a deck-level navigation input is received, then in block 412, the focus deck 214 is redisplayed with a card associated with the navigation input as the top card. In the case where the card associated with the navigation input is a sub-deck, then the graphics subsystem 206 may be configured to either display the cards of the sub-deck within the current deck, or display the sub-deck in a different portion of the display screen. In an exemplary embodiment, menus and soft keys may change based on the card or cards 214 with focus.

In block 414, if an activate card input is received, then in block 416, a default action based on a characteristic of a resource represented by the top card is performed. For example, if the resource represented by the top card is a software application, then the default action may be to execute the software application. If the resource represented by the top card is a file folder or menu, then the default action may include opening a window to display the contents of the resource.

In block 418, if a return to top card input is received, then in block 420, the focus deck is redisplayed with the deck's default top card. With this feature, the user may set a default “home” card that can be returned to at any time during deck navigation with an input control, preferably using an input control different from that used for deck navigation. For example, the user could configure a home key on the keypad 210 for instance.

In block 422, if a default ordering input is received, then in block 424, the focus deck is redisplayed in a default ordering. Similar to the home key described above, the user may configure one of the input controls to return the user from navigation within the deck to a default ordering of the deck 214. The input subsystem 208 is further configured to accept a user-configurable deck organization that includes sorting the cards of the deck using at least one of a card name, a card type, a card date, most recently used cards. In an exemplary embodiment, this is shown in FIG. 2 under an “Options” menu that displays to the user various sort options.

Referring again to FIG. 4, in step 426, if an input control or sequence is received to return to the main display screen 216, then in step 428, the main display screen 216 is displayed to return the user from viewing an activated resource. In one embodiment, a window displaying an opened resource is closed upon returning to the main display screen 216. In another embodiment, the window displaying the open resource may remain open, but runs in the background.

In a further embodiment, the decks 214 displayed on the main display screen 216 may be changed based on the card(s) with focus. In this embodiment, a base set of decks 214 may be defined, as well as an input control that allows the user to return to the display of the base set of decks.

In accordance with an exemplary embodiment, most of the input navigation sequences shown in FIG. 4 may be performed on either a single deck or simultaneously on multiple decks. In this embodiment, the system 200 allows the user to select at least two of the decks 214 and to navigate the decks 214 simultaneously.

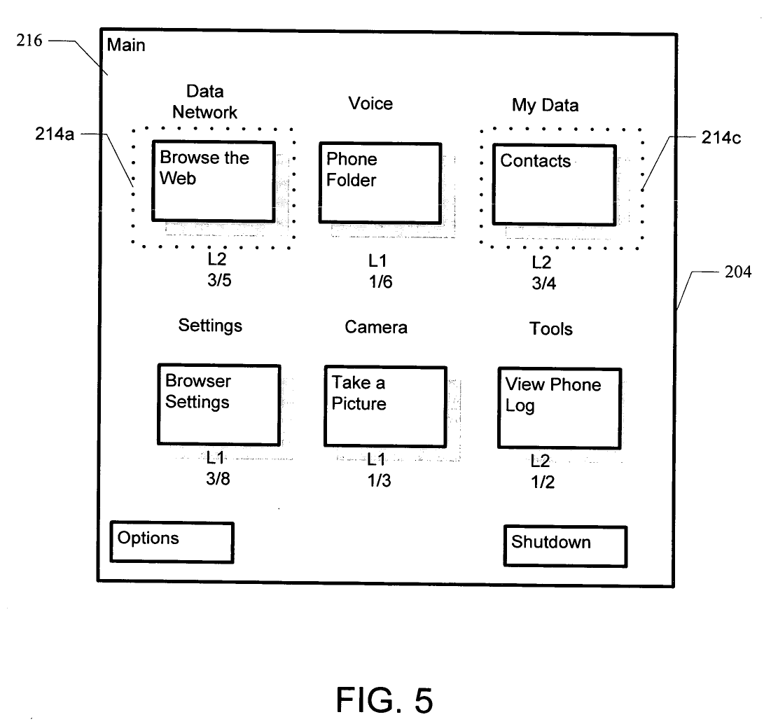

FIG. 5 is a block diagram illustrating an embodiment of the system 200 in which multi-deck selection is allowed for simultaneous navigation. In the example shown, the user has selected the “Data Network” deck 214a and the “My Data” deck 214c, both of which have focus as shown by the two dashed-line highlights. As the user presses an input control, such as left or right key 212, the top cards in each of the two decks 214a and 214c are removed to reveal the next card in each deck 214a and 214c. If navigation and location information is displayed, then the navigation and location information is updated for both decks 214a and 214c accordingly. This feature may be useful if the user has multiple decks of images, movies, or songs and wishes to scan them all simultaneously.

According to a further embodiment, the system 200 enables relationships between multiple decks 214 to be specified. According to the exemplary embodiment, when a top card is displayed in one the focus deck 214, the system 200 automatically recognizes the cards in other decks 214 to which the first top card has at least one relationship in order to place the cards with related functions near the tops of the other deck 214.

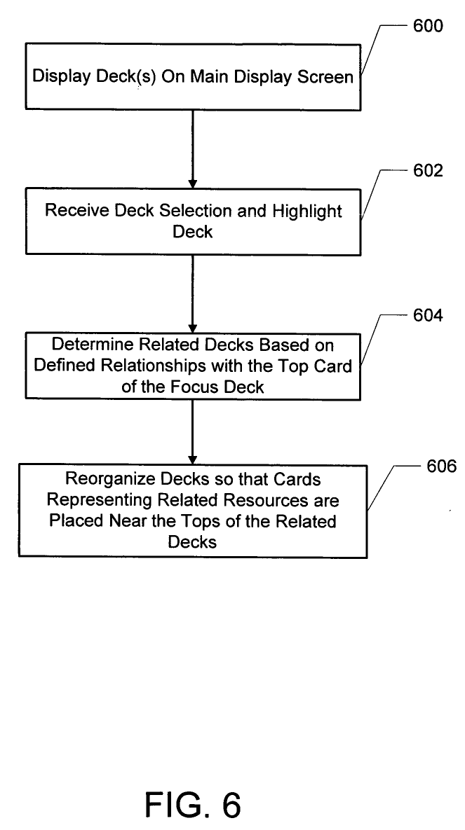

FIG. 6 is a flow diagram illustrating the process of displaying content of a related deck as the user navigates a focus deck in accordance with an exemplary embodiment. The process begins in block 600 by displaying the decks 214 on the main display screen 216. In block 602, an indication of a selected deck 214 is received and the selected deck is highlighted.

In block 604, related decks 214 are determined based on defined relationships with the top card of the focus deck 214. In one embodiment, the relationships between decks 214 may be specified by the user. In a second embodiment, the relationships between decks 214 are automatically discovered using metadata associated with the resources corresponding to the cards in the decks 24. In a third embodiment, the relationships are automatically discovered using records of the user and device activity.

In block 606, the related decks 214 are reorganized so that cards representing resources related to the top card to focus deck 214, or otherwise having related functions, are placed near the tops of the related decks 214. Preferably, the related cards are placed at the tops of the other decks. Thereafter, navigation proceeds as described with respect to blocks 404-428 of FIG. 4.

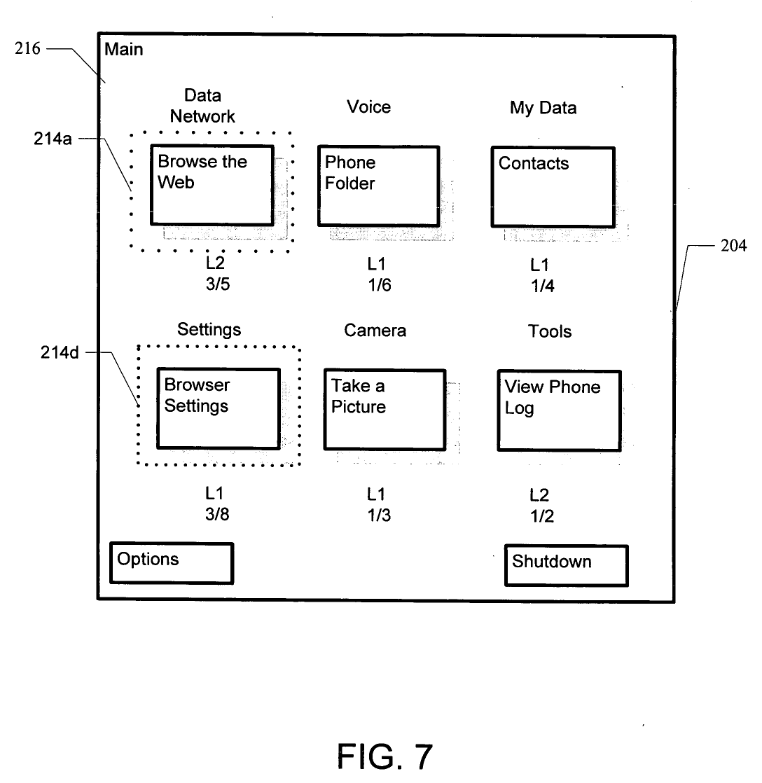

FIG. 7 is a diagram illustrating the display of a deck 214a with focus and a deck 214d that has a defined relationship with the focus deck 214a. In this example, assume that the user navigates to the “Browse the Web” card in the “Data Network” deck 214a, the system 200 may then move the “Browser Settings” card to the top of the “Settings” deck 214d, since browser settings may be relevant to browsing the Web. The system 200 may automatically highlight any decks 214d having a relationship with the focus deck 214a, as shown. As another example, assume that the user gives a “Phone Card” focus in the “Voice” deck 214b, then the system 200 may automatically move an “Address Book” card to the top of the “My Data” deck.

A user scenario will now be provided to further illustrate use of the deck GUI of the exemplary embodiment. In this scenario, assume that Bob wants to call his friend Pete using the system 200. To do so, he navigates to a Communications deck and then to the phone icon card within the Communications deck to activate the phone function. According to the exemplary embodiment, as he navigates the Communications deck, the MyData decks reorganizes automatically and places Bob's address book card on top. Bob's address book has reconfigured itself to display of names and phone numbers of each contact prominently. Bob moves to the deck with his address book, and activates the address book card to open it. Bob quickly finds Pete's entry since it's automatically placed near the top of the address book because Bob calls Pete a lot. The default action for opening Pete's entry is to call him since the phone card is on top of a related deck. Bob selects Pete's entry. The dialing screen appears on top of the main screen. The call goes through and they talk. When Bob presses the end call button, the call is ended, the screen on top is closed and the main screen with the decks is displayed in its last form. Bob presses his ‘*’ button and the Select button together. The main screen returns all the decks to their default organization, and location.

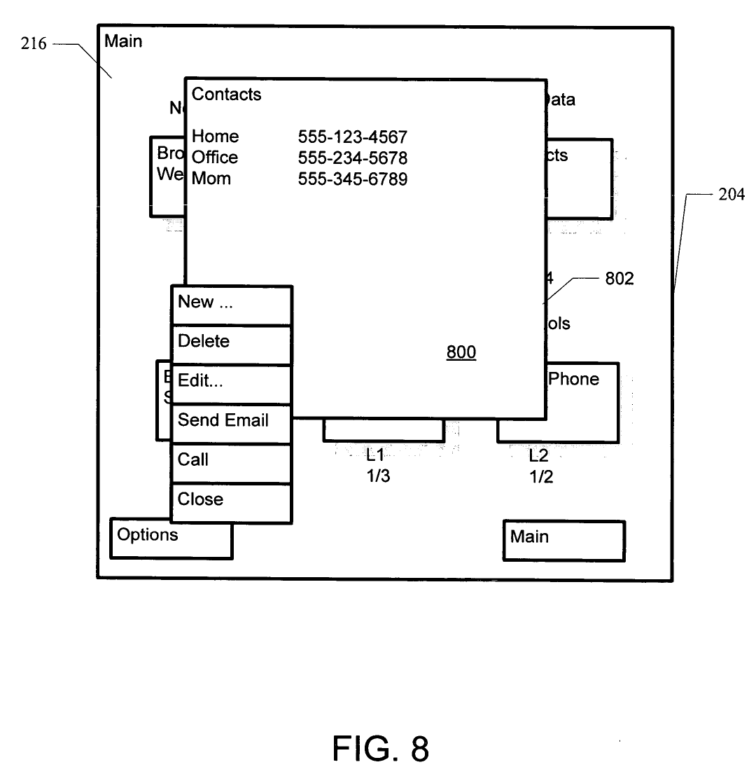

FIG. 8 is a block diagram illustrating an exemplary embodiment for displaying an open resource, such as an address book, and for performing administrative functions on the open resources, including decks and cards. In this example, an address book of contacts 800, which is an opened resource, is displayed in its own window 802 on the display 204. Two softkeys, an “Option” key 804 and a “Main” key 806, are also displayed. By clicking on the Option key 804, the system 200 will display several options that can be performed specific to the opened resource, i.e., the address book 800. The options may include creating a new contact, deleting the focus contact, editing the contact, sending an email to the contact, initiating a call to the contact, and closing the address book 800.

In another exemplary embodiment, running applications, such as the address book, may be each represented as cards that comprise an active resource deck of cards. The active resource deck may then be displayed along side the other decks 214 on the main display screen. The cards of the active resource deck will change dynamically based on the opening and closing of applications.

According to a further embodiment, the Option key (or other input control) may also be used to perform administrative functions on a focus deck 214, or on a top card in the deck. For a single deck, card options may include deleting the deck, creating a new deck, and copying the deck.

Options displayed for the top card may include creating a new card, deleting the top card, copying the top card, and moving the top card. When a new card is created, the user may be given the option to create a standard card or a sub-deck. When a card is deleted, the next card in the deck is automatically revealed. Creating a new card results in a new blank card being displayed as the top card. When a card is copied, the user is given the option to create the copied card in the focus deck, or to create the copied card in another deck of the user's choosing. When a card is moved, the user is given the option to move the card to a different location within the focus deck, or to delete the card from the focus deck and place it into another deck of the user's choosing.

If the top card is a sub-deck and the user chooses the copy option, then the user may be given the option to create the copied sub-deck in the focus deck, or to create a new deck from the sub-deck (leaving the top card sub-deck in the focus deck in place). If the user chooses to move the top-card sub-deck, then the user may be given the option to move the sub-deck to a different location within the focus deck, or to delete the sub-deck from the focus deck and place it in another deck of the user's choosing, or to delete the sub-deck from the focus deck and use the sub-deck to create a new deck.

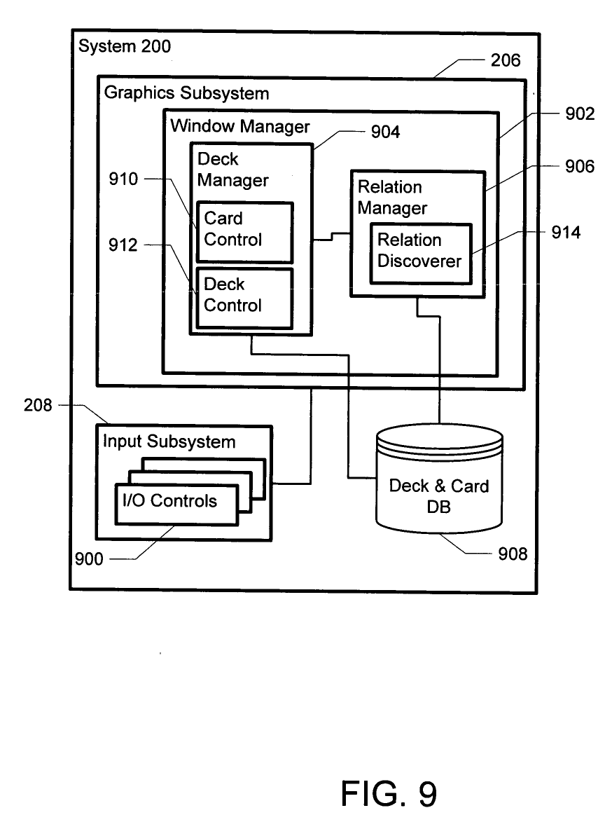

FIG. 9 is block diagram illustrating additional components of the system for implementing the present invention according to an exemplary embodiment, where like components from FIG. 2 have like reference numerals. The graphics subsystem 206 includes components such as the display, display hardware, memory, drivers (none shown). The graphics subsystem 206 further includes a windowing manager 902 that is used by the system and applications for presenting information to the user. As described above, the input subsystem 208 includes input controls 900, such as buttons, toggles, sliders, pointing devices, and the like. Input received from the input controls 900 is provided to the window manager 902 (if it has the focus) to interpret the meaning of each input.

A deck and card database 908 stores data structures representing cards and decks 214. The deck and card database 908 further stores mappings defining the relations between applications to mime types, relationships between decks, relationships between decks and applications, and relationships between applications.

The window manager 901 further includes a deck manager 904 and a relation manager 906 that interface with the deck and card database 908. The deck manager 904 manages and contains a deck and card UI control 910, and manages the storage of the current, default, and any other saved deck/card organizations. The deck manager 904 interprets the input events received from the input subsystem 208 to enable navigation between decks, in decks, and into and out of nested decks. The deck manager 904 also allows for the creation, deletion, and management of decks and cards.

The relation manager 906 provides a system where deck and card relationships may be specified. The relation manager 906 may allow the user to specify the relationships, or automatically discovers relationships using any metadata associated with represented resources. Optionally, the relation manager 906 supports a learning engine which uses records of user and system activity to discover card and deck relationships.

The executable instructions of a computer program as illustrated in FIG. 1, providing for navigating a multi-resource user interface on a display of an electronic device, can be embodied in any computer readable medium for use by, or in connection with an instruction execution system, apparatus, or device, such as a computer based system, processor containing system, or other system that can fetch the instructions from the instruction execution system, apparatus, or device and execute the instructions.

As used here, a “computer readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non exhaustive list) of the computer readable medium can include the following: an electrical connection having one or more wires, a portable computer diskette, a random access memory (RAM), a read only memory (ROM), an erasable programmable read only memory (EPROM or Flash memory), an optical fiber, and a portable compact disc read only memory (CDROM).

A method and system for navigating a multi-resource user interface on a display of an electronic device has been disclosed. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method providing for navigating a multi-resource user interface on a display of an electronic device, comprising:
displaying a deck of cards representing device resources in a presentation space occupying only a portion of a display screen, wherein a top card overlaps other cards in the deck such that no user interface controls of the other cards are visible and only the top card is selectable by a user; and
in response to the user activating an input control to navigate the cards in the deck, moving the top card to another position in the deck and revealing a next card in the deck.

2. The method of claim 1 further comprising providing at least one card in the deck representing a nested sub-deck of cards.

3. The method of claim 2 wherein when the card representing the nested sub-deck is selected, displaying the sub-deck in the portion of the display screen with a next card in the sub-deck displayed as a top card in the displayed sub-deck.

4. The method of claim 3 further comprising displaying the sub-deck in a different portion of the display screen.

5. The method of claim 3 further comprising providing the user with an option to perform at least one of creating a new sub-deck, deleting the sub-deck, copying the sub-deck, and moving the sub-deck.

6. The method of claim 4 wherein if the user chooses the copy option, then the user is given the option to perform at least one of creating a copied sub-deck in the focus deck, and creating a new deck from the sub-deck.

7. The method of claim 5 wherein the displayed deck containing the sub-deck is a focus deck, the method further comprising if the user chooses the move option, then the user is given the option to perform at least one of moving the sub-deck to a different location within the focus deck, deleting the sub-deck from the focus deck and placing the sub-deck in another deck, and deleting the sub-deck from the focus deck and using the sub-deck to create a new deck.

8. The method of claim 1 further comprising providing a visual indication to the user of a current location of navigation within the deck.

9. The method of claim 1 wherein the deck includes a default home card, the method further comprising providing a second input control to return the user from navigation within the deck to the home card of the deck.

10. The method of claim 1 wherein the deck includes a deck ordering, the method further comprising providing a second input control to return the user from navigation within the deck to the default ordering of the deck.

11. The method of claim 1 wherein displaying a deck of cards further includes displaying multiple decks of cards in respective portions of the display screen.

12. The method of claim 11 further comprising allowing the user to select at least two of the decks and to navigate the at least two decks simultaneously.

13. The method of claim 11 further comprising allowing relationships between the multiple decks to be specified.

14. The method of claim 13 wherein when a card is a top card with focus in a first one of the multiple decks, automatically recognizing the cards in other decks to which the first deck has at least one relationship in order to place cards with related functions near the tops of the other decks.

15. The method of claim 14 wherein the relationships are specified by the user.

16. The method of claim 14 wherein the relationships are automatically discovered using metadata associated with the resources corresponding to the cards in the decks.

17. The method of claim 14 wherein the relationships are automatically discovered using records of the user and device activity.

18. The method of claim 1 further comprising enabling a user-configurable deck organization that includes sorting the cards of the deck using at least one of a card name, a card type, a card date, and most recently used cards.

19. The method of claim 1 wherein the deck of cards comprises an active resource deck of cards and each of the cards in the active resource deck of cards represents currently activated device resources.

20. The method of claim 1 further comprising providing the input control with a set of buttons wherein activation of a first one of the buttons displays the next card in the deck, and activation of a second one of the buttons displays a previous card in the deck to allow the user to traverse the deck in a forward and a reverse direction.

21. The method of claim 20 further comprising simultaneously displaying multiple decks on the display screen, allowing the user to navigate among the multiple decks to select a particular deck, and displaying a visual indication of the selected deck.

22. The method of claim 21 further comprising allowing the user to navigate among the multiple decks by a double activation of the input control.

23. The method of claim 1 further comprising performing a default action in response to the user activating the top card in the deck based on a characteristic of a resource the top card represents.

24. The method of claim 23 wherein performing the default action includes executing the resource when the top card in the deck represents a software application.

25. The method of claim 23 wherein performing the default action includes opening a window to display contents of the resource when the top card in the deck represents one of a file folder and a menu.

26. The method of claim 1 further comprising allowing the user to return directly from a resource activated via the deck of cards to the display screen using a second input control.

27. The method of claim 26 further comprising closing the opened resource upon returning to the display screen.

28. The method of claim 26 further comprising running the activated resource in a background mode upon returning to the display screen.

29. A computer-readable medium containing executable program instructions for navigating a multi-resource user interface on a display of an electronic device, the executable program instructions for:
displaying a deck of cards representing device resources in a presentation space occupying only a portion of a display screen, wherein a top card overlaps other cards in the deck such that no user interface controls of the other cards are visible and only the top card is selectable by a user; and
in response to the user activating an input control to navigate the cards in the deck, moving the top card to another position in the deck and revealing a next card in the deck.

30. A system providing for navigating a multi-resource user interface on a display of an electronic device, comprising:
a display configured to display a display screen;
a graphics subsystem coupled to the display that is configured to display a deck of cards representing device resources in a presentation space occupying only a portion of a display screen, wherein a top card overlaps other cards in the deck such that no user interface controls of the other cards are visible and only the top card is selectable by a user; and
an input subsystem coupled to the graphics subsystem that is configured to determine when the user activates an input control to navigate the cards in the deck, wherein in response, the graphics subsystem moves the top card to another position in the deck and reveals a next card in the deck.

31. A method providing for navigating a multi-resource user interface on a display of an electronic device, comprising:
displaying a deck of cards representing device resources on a display screen, wherein a top card overlaps other cards in the deck such that no user interface controls of the other cards are visible and only the top card is selectable by a user;
providing at least one card in the deck representing a nested sub-deck of cards; and
when the card representing the nested sub-deck is selected, displaying the sub-deck on the display screen with a next card in the sub-deck displayed as a top card in the displayed sub-deck.

32. The method of claim 31 further comprising displaying the deck in a first portion of the display screen and displaying the sub-deck in a second portion of the display screen.

33. The method of claim 31 further comprising providing the user with an option to perform at least one of creating a new sub-deck, deleting the sub-deck, copying the sub-deck, and moving the sub-deck.

34. The method of claim 33 wherein the displayed deck containing the sub-deck is focus a focus deck, the method further comprising if the user chooses the copy option, then the user is given the option to perform at least one of creating a copied sub-deck in the focus deck, and creating a new deck from the sub-deck.

35. The method of claim 33 wherein the displayed deck containing the sub-deck is focus a focus deck, the method further comprising if the user chooses the move option, then the user is given the option to perform at least one of moving the sub-deck to a different location within the focus deck, deleting the sub-deck from the focus deck and placing the sub-deck in another deck, and deleting the sub-deck from the focus deck and using the sub-deck to create a new deck.
